(19) United States
(12) Patent Application Publication
(10) Pub. No.: US 2021/0106048 A1
(43) Pub. Date: Apr. 15, 2021

(54) Pre-Filter Method for Personal Smoke Filtration System

(71) Applicant: Craig Alan Nowak, Redondo Beach, CA (US)

(72) Inventor: Craig Alan Nowak, Redondo Beach, CA (US)

(21) Appl. No.: 17/069,851

(22) Filed: Oct. 13, 2020

Related U.S. Application Data
(60) Provisional application No. 62/913,798, filed on Oct. 11, 2019.

(51) Int. Cl. A24D 3/04; B01D 53/26; B01D 53/28

(52) U.S. Cl. CPC A24D 3/04; B01D 53/266; B01D 53/28; B01D 53/263

(57) ABSTRACT

A method for adding pre-filtration to a HEPA filter canister of a smoke filtration system, the canister's having holes in the bottom for expelling exhaled breath, the canister having a removable mouth piece lid, the pre-filtration method comprising: adding a mat-type fastener that allows multiple fastening and separation on the bottom side of the mouth piece lid on a small diverter platform; the platform having small slits on the side to create a diverting effect, spreading air flow out before entering the HEPA filter, a piece of water absorbing sponge material with a mat-type fastener in the middle of the sponge material, placed to line up with the mat-type fastener on the small diverting platform; and a screen made hydrophobic material acting as breath barrier, with tabs a user can use to hold it in place during assembly, the outer perimeter of the mesh screen being wider all the way around than the canister opening, causing during assembly that the entire outer perimeter of the mesh screen to become pinched between the lid's inner ring and canister's inner circumference creating a seal of hydrophobic mesh separating the pre-filter up above and away from the HEPA filter.

### FIELD OF THE INVENTION

The present application relates to a pre-filtration method prior to a HEPA filter in a personal smoke filtration system with the goal of minimizing moisture that flows to the HEPA filter in order to extend the life of the HEPA filter.

### BACKGROUND

Regarding the life of HEPA filters, it is not the particulates or resin that create problems with the life of the filter, though that would be the case eventually, but long before the pleats of the HEPA filter and extra surface area they provide, with the intent of extending life span could ever be put to any sort of test, (in all the years these products have been available), due to the fact that breath moisture infiltrates the unit soaking the HEPA filters causing the filters to fail, this has always caused the unnecessary premature death of these type personal air filters.

Air purifiers, also known as air cleaners, are product that can adsorb, decompose or convert various air pollutants. Air purifiers, for smoke related to smoking tobacco or vaping, is mainly made up of parts such as a mouthpiece over a HEPA or other filter type, air circulation through the filter occurs after exhaled smoke is blown into the canister through the mouthpiece, the air pollution of particles over 0.3 microns are removed by the HEPA filter. An issue with current smoke filtration devices is that when HEPA filters get dirty they regenerated with cleaning, greatly limiting their life. Water content in the air or in the exhaled smoke, blown into the filter while the system is being use causes the main damage the HEPA filter.

In view of this, a pre-filter system is the needed to minimize the moisture that can reach HEPA filter, and ideally a pre-filter system that can be removed and allowed to dry or manually dried by user. This invention provides a removable sponge, easily separated from the inside of the mouthpiece lid for drying. Over time resin may build up in the pre-filtration system, in which case the mouthpiece lid, the diverter platform and slots, and the breath barrier mesh can be cleaned by soaking the mesh and sponge in rubbing alcohol for an hour allowing the pre-filter to work well again and the exhaust air to blow through freely.

This invention also provides a breath barrier screen made out of hydrophobic material that sits above the HEPA filter. This breath barrier screen also resists water, redirecting it back toward the sponge. Importantly, the breath barrier screen does not add a restriction to air flow. Another feature of this invention is the diverter platform with slits which spreads the air flow more evenly to the HEPA filter to also prolong life. The result is an improved the service life of both the HEPA filter and smoke removing air purifier device.

The removable and dryable sponge and the moisture barrier provided by the hydrophobic breath barrier screen are the two major methods of preventing moisture damage to the HEPA filter features that this pre-filter method provides.

### SUMMARY OF THE INVENTION

The main embodiment consist of a method for adding pre-filtration to a smoke filtration device featuring a HEPA filter, the canister holding the HEPA filter having holes in the bottom, with a removable mouth piece lid. The pre-filtration method comprising: adding a small diverter platform with slits on the side, adding a mat-type fastener on diverter platform which can be fastened and separated multiple times; adding a piece of water absorbing sponge material with a mat-type fastener on the sponge material that lines up with the mat-type fastener on the small diverter platform; and a breath barrier screen made hydrophobic material that fits, after the mouth piece lid is placed on the canister, over the top of the HEPA filter canister, the breath barrier screen, which is larger than the circumference of the canister is pinched after assembly between the lid's inner ring and the canister's inner circumference creating a seal of hydrophobic mesh separating the pre-filter up above and away from the HEPA filter.

Other embodiments include having a different fastening device on the inside of the mouthpiece lid and the sponge material. The diverter may also be made out of non-hydrophobic material and the sponge layer may be made out of another water absorbing material.

### OBJECTIVES OF THE INVENTION

To minimize the amount of moisture coming into the HEPA filter in order to extend its life.

To have an easy removal of the sponge material so it can dry either by being left out to dry, or through hand drying with a towel or other implement extending the life of The H EPA filter and the smoke filtration product.

### PART NUMBER DESCRIPTION

1. Personal Smoke Filtration Device
2. Canister
3. Location for HEPA filter
4. Holes on the side of the canister opposite the mouth piece lid
5. Mouthpiece lid
6. Mouthpiece
7. Mat-type fastener on the lid
8. Small diverter platform on mouthpiece lid that also extends the lid towards the sponge piece so that it lines up with the height of the mouth piece's lid inner ring.
9. Sponge piece
10. Mat-type fastener on sponge material place to line up with the mat-type fastener of the mouthpiece lid
11. Diverter screen made out of hydrophobic material, note the actual diverter screen has much smaller grids than this figure can show.
12. Tabs on the breath barrier screen that extend outside of the circumference of the canister on so that the screen can be held in place by hand during assembly.
13. Inner ring on the mouth piece lid that fits tightly to the inside circumference of the top of the canister holding the HEPA filter
14. Top inner circumference of the canister that fits tightly against the inner ring of the mouth piece lid, the tight fit pinching the breath barrier screens outer circumference.
16. Area under the platform which has a post with slits to act as a diverter.

### BRIEF DESCRIPTION OF DRAWINGS

FIG. 1 shows an overview of the entire smoke filtration device.

FIG. 2 shows the canister that the HEPA filter fits within.

FIG. 3 shows the underside of the lid, showing the raised inner ring, the small diverter platform and location of the mat-type fastener

FIG. 4 shows the sponge layer with its location of the mat-type fastener that lines up with the mat-type fastener on the mouth-piece lid.

FIG. 5 shows how the sponge layer and the mouthpiece lid line up prior to placing the sponge into the mouth piece lid

FIG. 6 shows the hydrophobic breath barrier screen, which is a moisture barrier, and the tabs on the diverter screen that are used to hold the screen in place held by the user held prior to assembly.

FIG. 7 shows the breath barrier screen, with the tabs for the user to hold it in place during assembly, the breathe barrier screen being larger than the canister diameter.

FIG. 8 shows how the excess from the breath barrier screen is captured between the inner diameter of the canister and the inner ring of the lid, holding the breathe barrier screen in place.

FIG. 9 shows a % view of the lid from the bottom, showing the platform, which has slits on a post underneath the platform that acts as a diverter.

### DETAILED DESCRIPTION

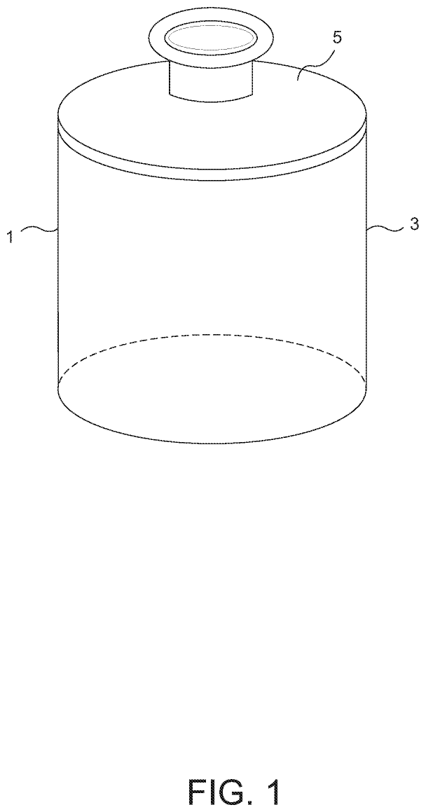

FIG. 1 shows the outside of the personal smoke filter 1 that housed the components of pre-filtration method. The canister 2 holds a HEPA filter. The mouthpiece lid 5 has, on the exterior, a mouthpiece 6, and the mouthpiece lid 5 is the same circumference as the canister 2, with the tight fit created by an pushing the inner ring on the mouthpiece lid into the inside circumference to the canister. Users breathe their exhaled smoke into the mouth piece where it goes first through a small diverter platform to a sponge layer which absorbs moisture and then goes to the breath barrier screen made of hydrophobic material, which repels a certain amount of moisture, with the small divert platform, which spreads the exhaust air flow out across the HEPA filter, once through the HEPA filter, the exhaust air exits through holes on the bottom of the canister.

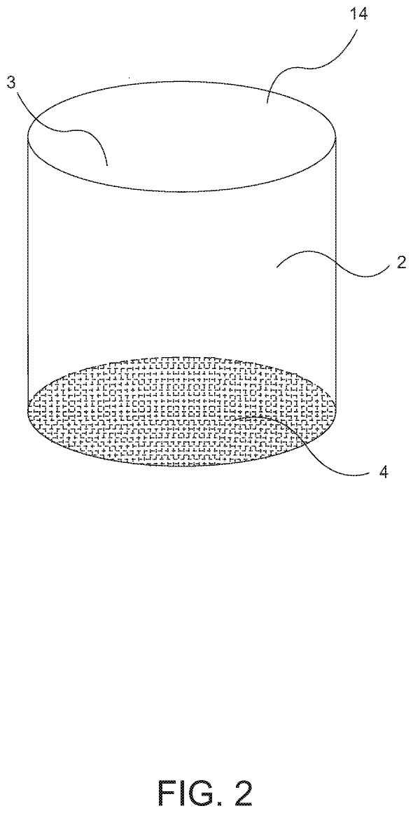

FIG. 2 shows the canister with openings in the bottom 4 to allow air flow out of the canister 2 after it goes through the HEPA filter, whose location 3 lies inside of the canister. The openings in the bottom 4 allow air to pass minimizing air restriction.

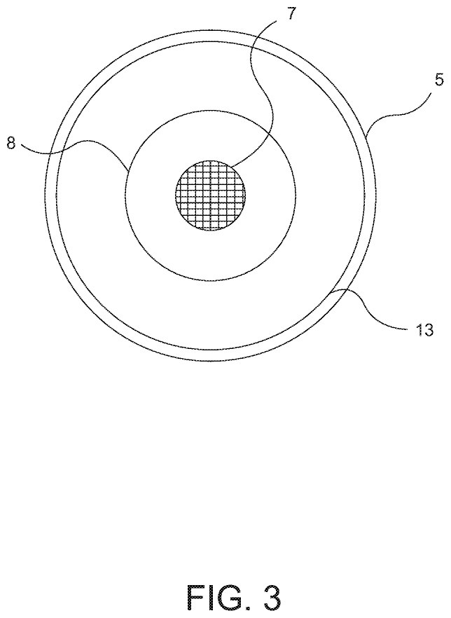

FIG. 3 shows the underside of the mouthpiece lid 5, showing the raise inner ring 13, the small diverter platform 8 extends to a slightly lower height that the inner ring, the height difference to allow the sponge material, after attaching to the platform, to line up with the height of the raise inner ring 14. The figure also show the mat-type fastener on the center of the small diverter platform 7. The mat-type fastener can be attached and then separated multiple times.

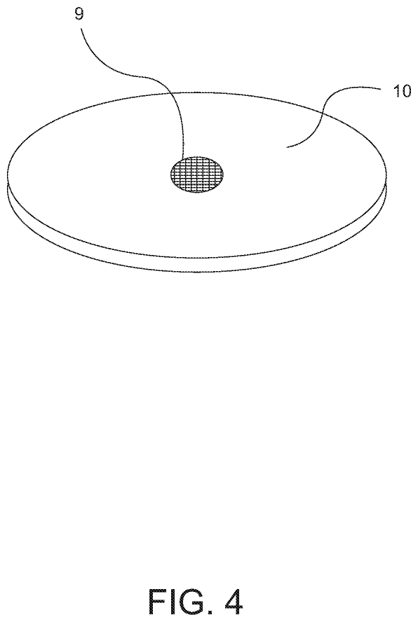

FIG. 4 shows the sponge piece 9 with its mat-type fastener 10, the mat-type fastener is place to line up with the mat-type fastener on the platform in the mouthpiece lid. The mat-type fasteners allow both the sponge material 9 and mouthpiece lid 5 to be easily separated and cleaned.

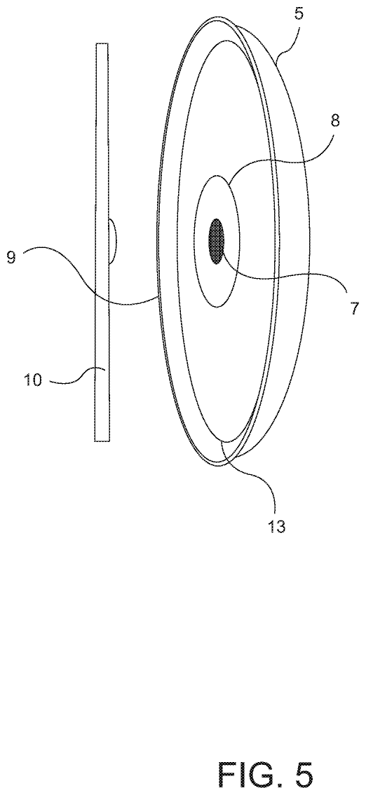

FIG. 5 shows how the sponge piece 9 with its protrusion 10, fits into the depression 8 of the mouthpiece lid.

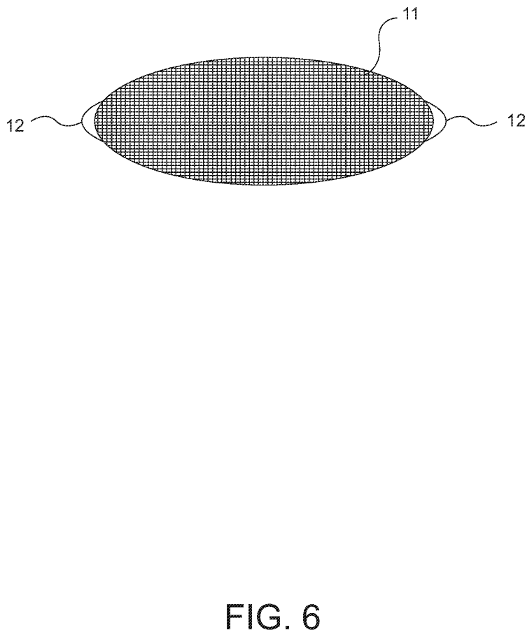

FIG. 6 shows the breath barrier screen 11 which has two small tabs 12 that squeezed between the inner ring 13 of the mouth piece lid and the inner circumference of the canister upon assembly. This is a key point in the methods as it ensures the that the entire pre-filter setup is inside of the mouth piece lid 5 and most importantly away from and never touching the HEPA filter. If any part of the pre-filter, especially that sponge layer, is too close to the HEPA filter or touching the HEPA filter it would break the hydrophobicity and would create basically a channel for the water to just simply run straight into the HEPA filter. The breath barrier screen 11, due to its hydrophobic properties, will redirect moisture that may come through the sponge material back toward the sponge on the underside of the lid, the result that much of a users' breath moisture getting caught on the underside of the lid

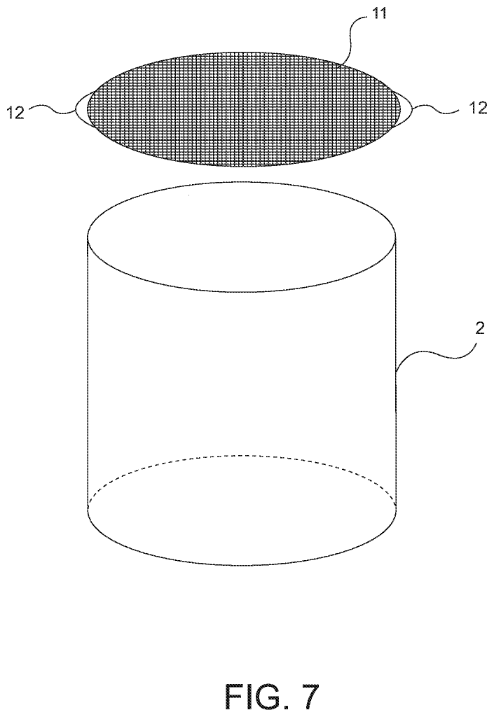

FIG. 7 shows the hydrophobic breath barrier screen 11 with its tabs 12 as it about to be placed on the top of the canister 2, prior to the lid's inner ringing being pushed inside the inner circumference of the canister.

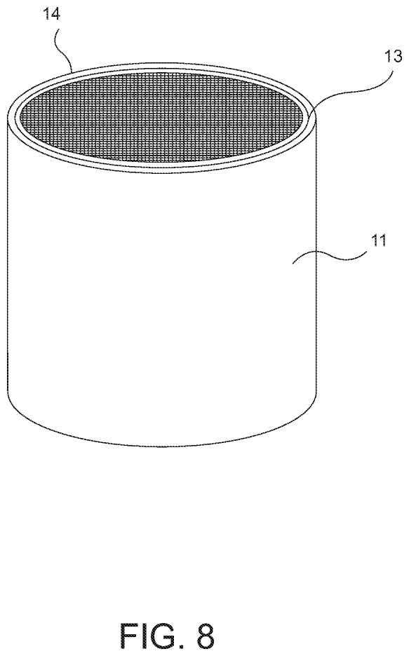

FIG. 8 illustrates the breath barrier screen 11 with its outer circumference which is larger than the inner circumference of the diameter of the canister 14, squeezed between the inner circumference of the diameter of the canister 14 and the inner ring of the mouthpiece top 13, note only the inner ring is shown in this figure, the rest of the mouthpiece top is not shown.

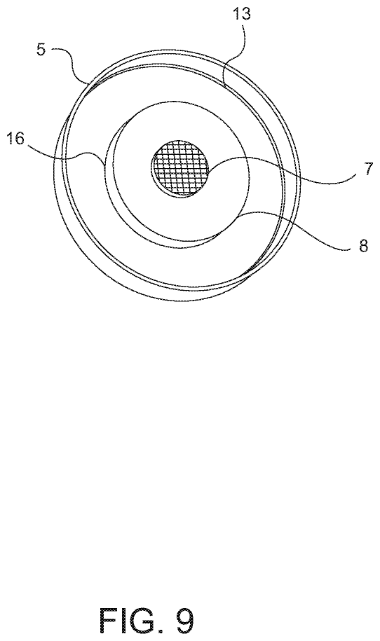

FIG. 9 shows the top at a % view, which shows the inner lid 13 of the mouthpiece lid, the area 16 under the platform 8 which as a post with slits and the mouthpiece fastener 7 on the mouth piece lid 5.

### METHOD FOR EXTENDING LIFE FURTHER

With traditional smoke removal products where users blow their breath into a HEPA filter, human breath is going to saturate that HEPA filter and ruin it by about 300 exhales. The purpose of this device is to greatly extend the HEPA filters life by putting pre-filter components in front of the HEPA filter, those main components being a sponge piece, a small diverter platform, and hydrophobic breath barrier that sits on the top of the canister holding the HEPA filter. The method depends on having a dry sponge. Life can be extended further when users have two units which allows the user to completely dry the sponge in one unit while using the other unit. This can be a major factor if the user frequently uses the personal smoke filtration device and doesn't have time for when using one unit only, which doesn't allow time for the sponge piece to dry out.

1. A method of providing moisture absorbing pre-filtration for personal smoke filtration canister systems by assembling pre-filter components into the personal smoke filtration system comprising:
removable sponge material which can be air of hand dried;
a hydrophobic breath barrier screen;
a removable mouth piece lid;
a small diverter platform underneath the mouth piece lid in line with the breath flow from the user;
the small diverter platform and sponge material connected by mat-type fasters that easily fasten and separate;
the mouth piece lid being configured with an inner ring to tightly fit into the inside circumference of the canister
the mouthpiece lid, upon assembly of the personal smoke filtration canister system, configure to pinch the outer circumference of the breath barrier screen between the mouth piece lid's inner ring and the inner circumference of the canister.

2. The method of claim 1 where a different fastener system is used to provide multiple fastening and separation activities.

3. The method of claim 1 where the breath barrier is constructed from non-hydrophobic material.

4. The method of claim 1 where another water absorbing material is used instead of the sponge.
